(19) United States
(12) Patent Application Publication
(10) Pub. No.: US 2007/0163180 A1
(43) Pub. Date: Jul. 19, 2007

(54) Smart handle and hinge system

(76) Inventor: Robert Harold Steinberg, Telzstone (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 10/597,001

(22) PCT Filed: Jan. 3, 2005
(86) PCT No.: PCT/IL05/00004

§ 371 Date: Jul. 6, 2006

(30) Foreign Application Priority Data
Jan. 6, 2004 (IL) 159720

(51) Int. Cl. E05D 7/02

(52) U.S. Cl. 49/382

(57) ABSTRACT

A mounting system for a closure which enables the closure to be opened from at least two sides. The closure includes handles mounted on the two sides and is mounted to a frame which the closure closes with the at least two sides. The closure only be opened from one of the sides at a time. The mounting system includes a locking and releasing mechanism on each of the sides, at least one hinge attached to each of the respective sides, a control bar attached to each hinge, the bar substantially locked into a respective control system, and a control circuit comprising a sensor and a relay, associated with each of the handles, whereby if a person opens the closure from one side, the sensor on that side activates the corresponding relay to operate the control system on that side of the closure and the hinge on that side is retracted.

### FIELD OF THE INVENTION

The present invention relates generally to systems for opening doors, windows, hatches, or other apertures or openings, and more particularly to such a system that has multiple handles or other opening means, whereby the door, window, hatch, or other aperture or opening can be opened from more than one side.

### BACKGROUND OF THE INVENTION

Doors, windows, hatches, or other apertures or openings normally are hinged on one side and open from the opposite side

Doors that open from either side are known in the art.

One very well known one is the Jacob's ladder toy, one of the most ancient and famous of folk toys. The apparent falling of the blocks has to do with a double-acting hinge. The principle of this toy can be applied to a simple mechanical means for opening a door from either side. Legend has it that the Jacob's ladder toy was found in King Tut's tomb, having been placed there about 3500 years ago.

Referring now to a Jacob's ladder toy 10 illustrated in side view prior art FIG. 1a, the top block 11 is shown held in a person's hand 20. To operate toy 10, simply hold the top block 11 by its edges and let the rest of the identical blocks swing downward, alternately from one side and then the other, until the “ladder” is fully open. Then, holding top block 11 by its edges, turn it 180° in a left rotation, until top block 11 and the second block 12 are parallel and touching. When held top block 11 hits the hanging second block 12, and a series of subsequent moving blocks, beginning with block 13 will begin cascading down. Then repeat the motion 180° to the right. Each time one moves top block 11 by 180°, a cascade of apparently moving blocks will flip to the bottom.

FIGS. 1b and 1c are front and back prior art schematic illustrations of the first of a pair of blocks 13 and a second of the pair of blocks 14, showing the exemplary connection between each pair of blocks of the Jacob's ladder toy 10 of FIG. 1a. When one holds two blocks horizontally on each other, then they have two hinges. One can open them either from the left or the right. The double-acting hinge is effected herein by attaching ribbons of cloth. A first ribbon 30 is attached at the center of non-adjacent ends of the two blocks, and two additional ribbons 40 are attached at the outside portions of the opposite non-adjacent ends of the two blocks.

In May, 1954 Philco™ advertised “World's First Refrigerator that Opens from Either Side!” This type of door typically has holes for pin-type hinges that are mounted between upper and lower projections from the frame and the door. The refrigerator could be ordered with the pins installed on one side or the other. The handle is mounted on the opposite side.

As for mechanical, non-automatic configurations in the prior art, Yates et al, for example, in US Patent Application 2004/0226141 teach a refrigerator door that has a Reversible Door Handle. The door has left and right door edges, which include a grip generally perpendicular to the left and right door edges and spanning between two handle coupling members. The grip is reversibly positionable in proximity to either of the left or right door edges. A handle extension is coupled to the grip by a connector plate that couples a first end of the handle extension to an adjacent one of the two handle coupling members. The connector plate is configured to couple the handle for use with either a left-hand or right-hand door. The handle extension extends away from the connector plate in a direction generally opposite the grip and couples with a door hinge on the opposite side of the door. The grip is symmetrically configured, such that the grip can be positioned for left-hand or right-hand door opening without turning the handle on the door surface.

In US Patent Application 2004/0182104, Choi describes a Door for Refrigerator in which a direction of opening and/or closing the door can be selectively changed. The door comprises in principal an external plate, which defines at least a front appearance of the door; a door liner, which defines a rear appearance of the door and constitutes a space with an insulating layer formed therein in cooperation with the external plate; a dispenser, which is installed at a front surface of the external plate for dispensing water to the outside of the refrigerator; two tube passages, which pass through the insulating layer and allow the dispenser and through-holes for installation of a hinge located at both sides of the door to communicate with each other.

The present state of the art discloses a door, where the direction of opening can be selectively changed from one side to the other, or back again. None of the refrigerator door embodiments discloses a double acting hinge

It would therefore be advantageous to provide a door that opens on more than one side, without having to move the hinges from one side to the other. Such embodiment can apply to enable the door to open from more than two sides and would therefore equally be applicable for use with windows, hatches or other apertures or openings.

### SUMMARY OF THE INVENTION

Accordingly, it is a principal object of the present invention to provide a door, window, hatch or other aperture or opening that opens on more than one side, without having to move the hinges from one side to the other.

It is another object of the present invention to provide a door, window, hatch or other aperture or opening that can open from more than two sides, as, for example, from top to bottom and from bottom to top, as well as from right to left and from left to right.

In one embodiment of the present disclosure, an electronic door system is disclosed that has multiple opening means, whereby a door can be opened from at least two sides. The door system includes a door with handles on at least the left and right sides. The door system also includes a frame, against which the door closes on at least the left side and the right side, and from which the door opens from only one side at a time and a normally closed electromagnet on each of the sides from which the door opens, each electromagnet operative for appropriately locking and releasing the door on each respective side. The door system further includes at least two hinges attached to each of the sides from which the door opens and a special electromagnetic bar attached to each of the at least two hinges, said bar substantially locked onto a respective electromagnet when in contact with said electromagnet at the time said electromagnet is activated, such that the door can be opened from at least a left and a right side, but only from one side at a time.

In an alternative embodiment the door is hinged and released on each side by means of solenoid-actuated pins that are appropriately extended and contracted.

In another alternative embodiment, a first refrigerator door is provided that hinges on one side and opens from the opposite side. Built into this first door is a second door that hinges and opens, respectively on the opposite sides of the first door. The multiple doors are provided with an electronic interlock, according to the principles of a preferred embodiment of the present invention described above.

Further embodiments would include hinges activated electronically, electromagnetically, electro-optically, hydraulically, pneumatically, mechanically, or by other means.

There has thus been outlined, in rather broad terms and scope, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings. FIGS. 1a, 1b, and 1c describe the Jacob's ladder toy, FIGS. 1d, 2, 3, and 4 describe a solenoid activated system, FIGS. 8, 9, 10, and 11 describe to an electromagnet activated system and FIGS. 5, 6, 7 12a and 12b relate two both these embodiments. In the accompanying drawings:

FIG. 1a is a prior art illustration, showing a side view of the Jacob's ladder toy;

FIGS. 1b and 1c are prior art illustrations, respectively showing front and rear views of the Jacob's ladder toy, so as to illustrate the method of connecting adjacent blocks of the toy shown in FIG. 1a;

FIG. 1d is a perspective view illustration of a refrigerator, shown with the door closed, constructed in accordance with an exemplary embodiment of the present invention;

FIG. 2 is a perspective view illustration of the refrigerator of FIG. 1d, shown with the door ajar, and showing an enlarged view of the top of the open end of the door, constructed in accordance with an exemplary embodiment of the present invention;

FIG. 3 is a perspective view illustration of the refrigerator of FIG. 1d, shown with the door ajar, and showing an exposed view of the closed door so as to illustrate the function of one of four solenoids retracted, constructed in accordance with an exemplary embodiment of the present invention;

FIG. 4 is a perspective view illustration of the refrigerator of FIG. 1d, and showing an exposed view of the closed door so as to illustrate the function of the solenoid extended, constructed in accordance with an exemplary embodiment of the present invention;

FIG. 5 is a schematic illustration of an embodiment of the present invention which illustrates the door being hinged on both the left and the right sides, such that electromagnets are used to lock and release the door appropriately on the left and right sides;

FIG. 6 is a schematic illustration of an embodiment of the present invention which illustrates the door being opened on the left side;

FIG. 7 is a schematic illustration of an embodiment of the present invention which illustrates the door being opened on the right side;

FIG. 8 is a schematic illustration of an embodiment of exemplary refrigerator of the present invention, which illustrates the refrigerator frame, with the door removed;

FIGS. 9a and 9b are front and rear views, respectively, of the door of FIG. 5, showing the details of the overall hinging mechanism;

FIG. 10 is a schematic illustration of an embodiment of the present invention which illustrates the door being opened from the left side, and showing more details of hinging mechanism;

FIG. 11 is a schematic illustration of an embodiment of the present invention which illustrates the door being closed against the frame, and shows the functioning of the hinge-pivot bar positioned in the hinge-pivot bar recess; and

FIGS. 12a and 12b are schematic diagrams of the electronic circuitry which controls the opening and closing of the door, constructed according to the principles of the present invention.

### DETAILED DESCRIPTION OF EMBODIMENT

The principles and operation of a method and an apparatus according to the present invention may be better understood with reference to the drawings and the accompanying description, it being understood that these drawings are given for illustrative purposes only and are not meant to be limiting. For illustration purposes, a soleroid activated door hinge embodiment is described.

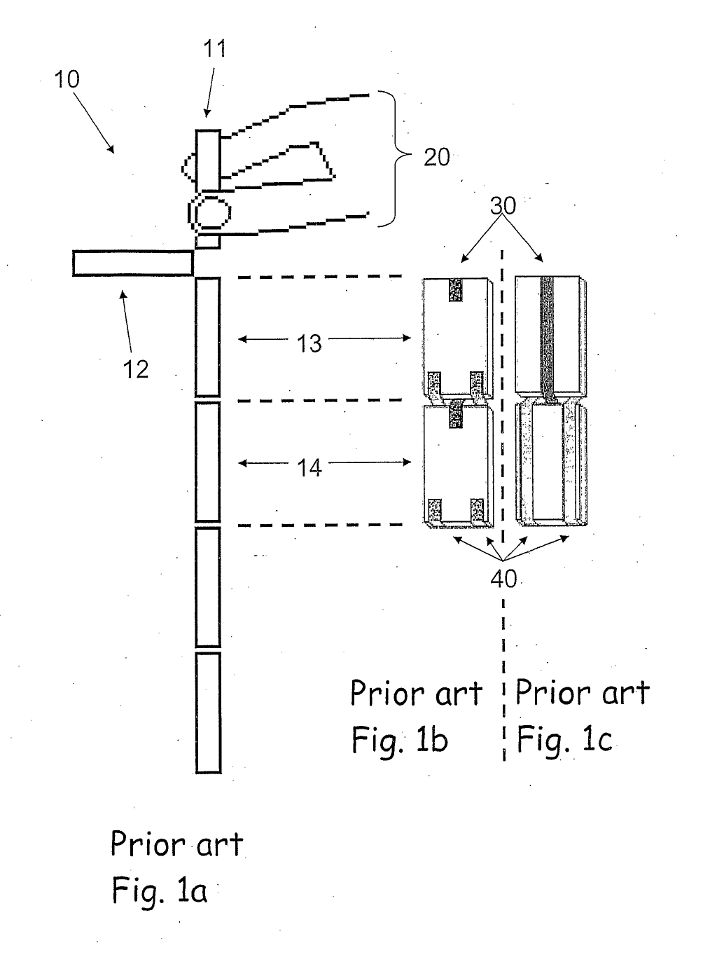

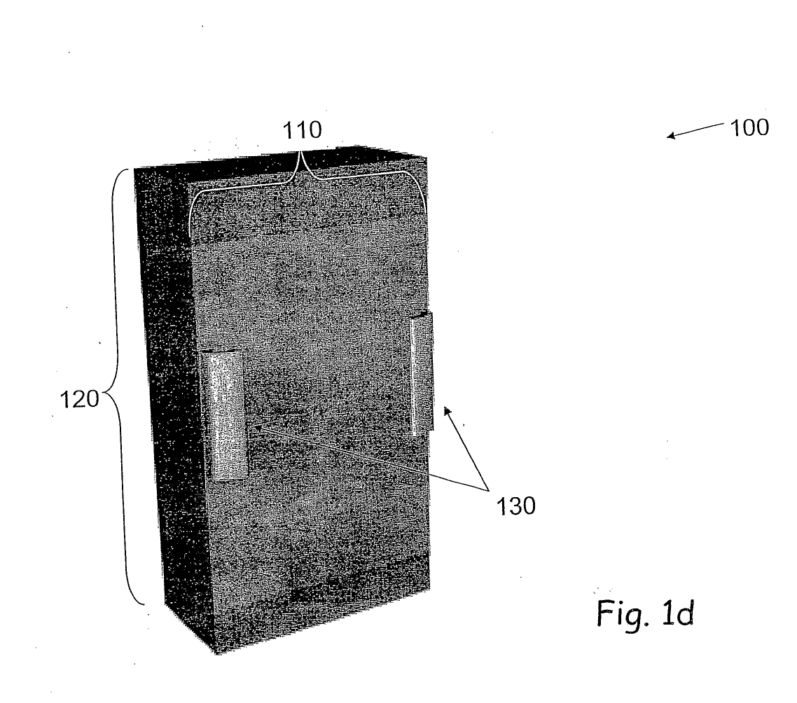

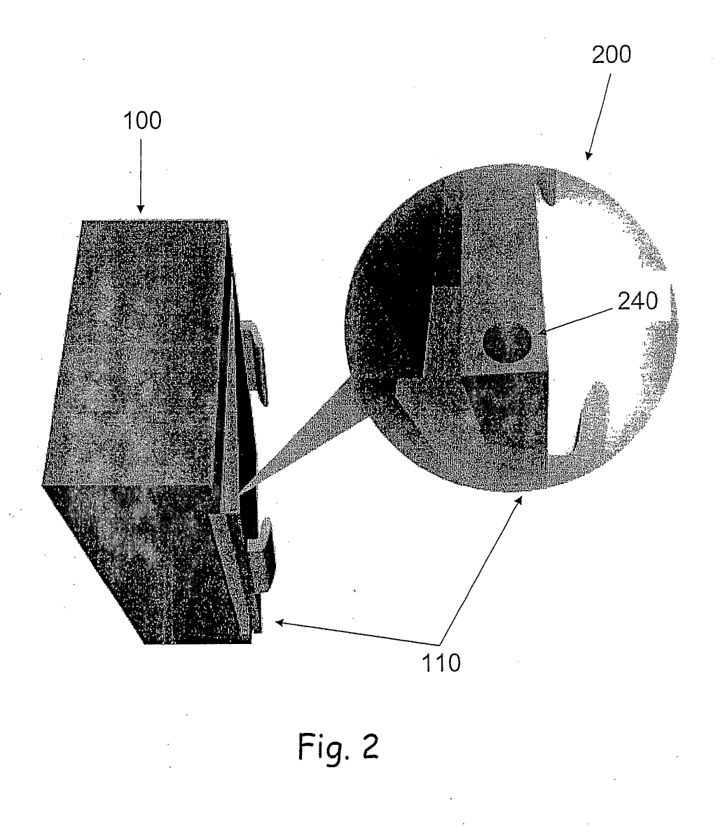

FIG. 1d is a perspective view illustration of a refrigerator 100, showing a solenoid actuated door hinge embodiment, shown with the door 110 closed against the refrigerator frame 120, constructed in accordance with an exemplary embodiment of the present invention. The two door handles 130 are shown on the left and right sides.

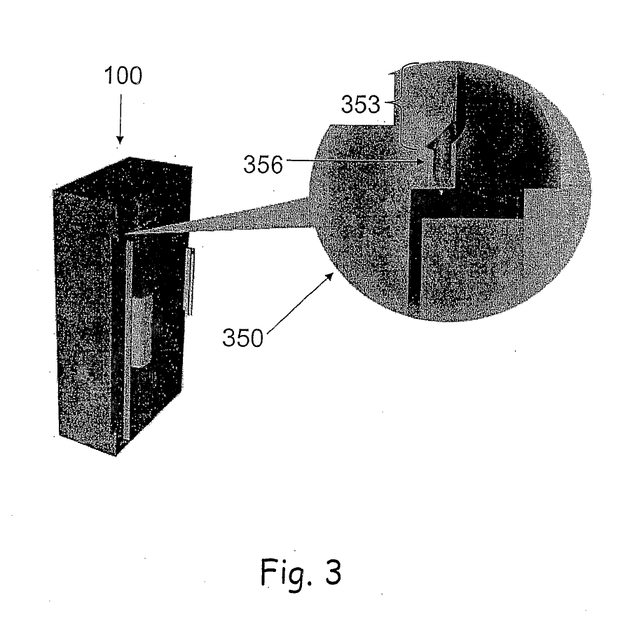

FIG. 2 is a perspective view illustration of the refrigerator 100 of FIG. 1d, again showing a solenoid actuated door hinge embodiment with door 110 slightly ajar, and showing an enlarged view 200 of the top of the open end of the door, constructed in accordance with an exemplary embodiment of the present invention. Enlarged view 200 shows a first cavity 240 at the top of door 110. Cavity 240 is designed to receive a solenoid driven pin that acts as a hinge when door 110 is opened from the opposite side. A second such cavity (not shown) is located at the bottom of the same side of door 110. Another such first and second pair of cavities (not shown) are located on the opposite side of door 110.

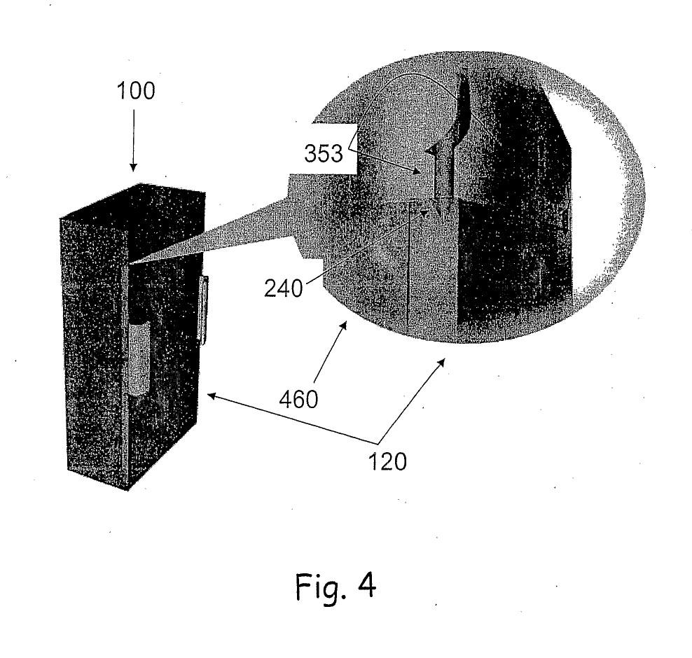

FIG. 3 is a perspective view illustration of the refrigerator 100 of FIG. 1d, again showing a solenoid actuated door hinge embodiment with door 110 slightly ajar, and showing an exposed view 350 of door 110 shown in FIG. 1 so as to illustrate the function of a solenoid 353 with its pin 356 retracted, constructed in accordance with an exemplary embodiment of the present invention. Thus, when pin 356 and its corresponding pin at the bottom of the same side of door 110 are retracted, door 110 can be opened from that side. When these two pins are extended into cavity 240 as shown in FIG. 2 and its corresponding cavity at the bottom of the same side of door 110, door 110 can be hinged from that side, and opened from the opposite side, provided the two corresponding pins on the opposite side of the door are retracted.

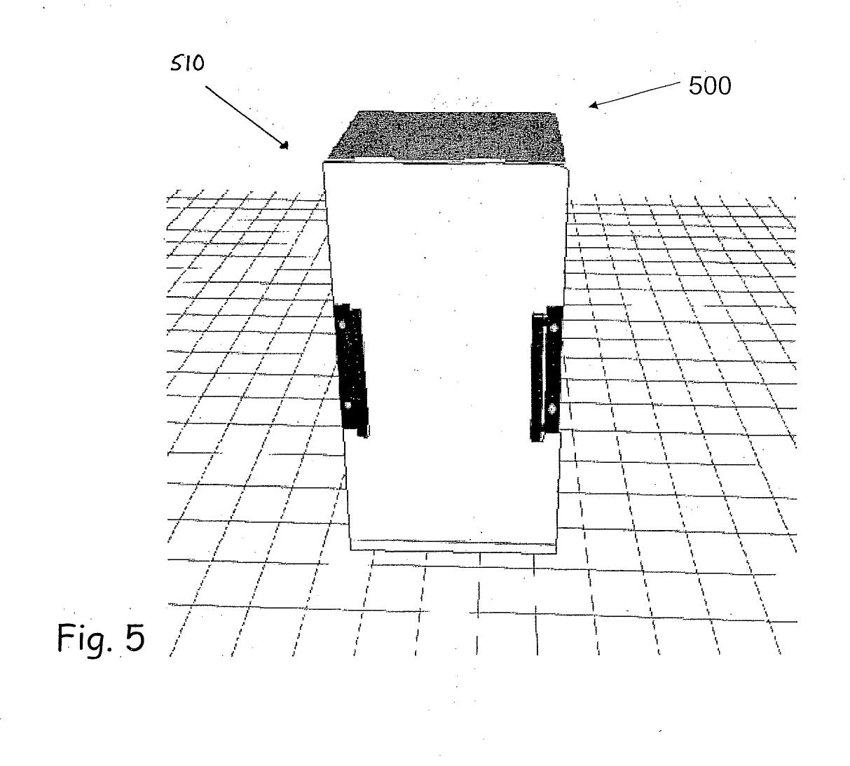

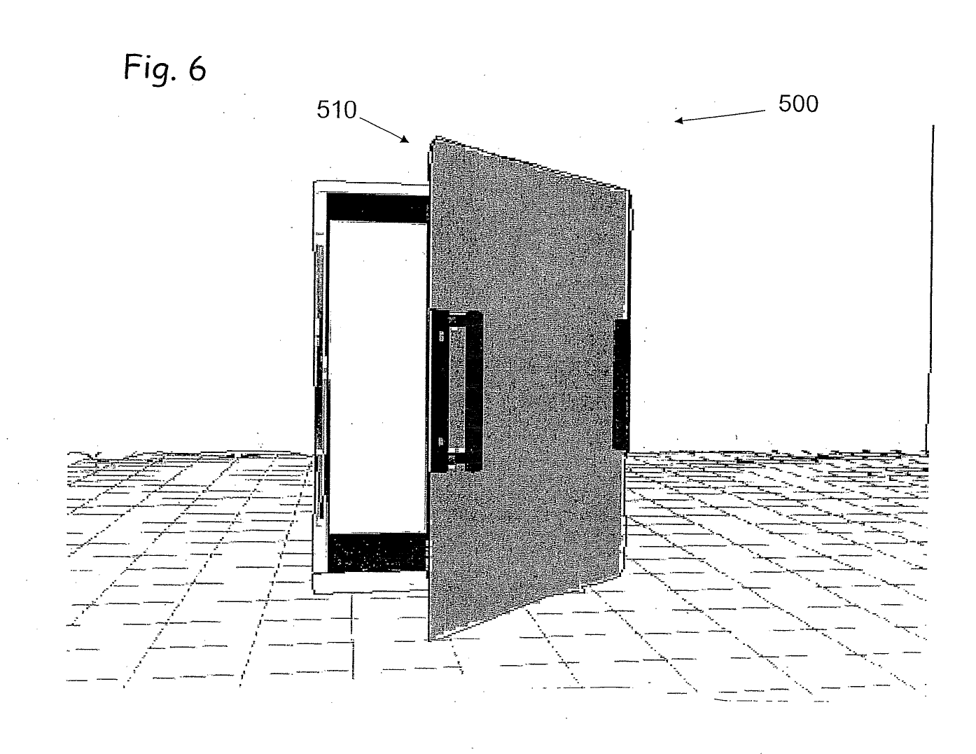

FIG. 4 is a perspective view illustration of the refrigerator 100 of FIG. 1d, and showing an exposed view 460 of closed door 110 so as to illustrate the function of both top solenoids with their pins 353 extended so as to prevent door 110 from opening from either side, constructed in accordance with an exemplary embodiment of the present invention. If a person extends a hand to open the door from the handle on either side, a sensor on that side activates a relay to operate the upper and lower solenoids on that side and pins 353 on that side are retracted. If both handles are approached simultaneously, only one of the solenoids is activated. The relays and sensors are not shown for this embodiment, but are identical to those used to illustrate the preferred embodiment of FIGS. 5 through 10, as described below.

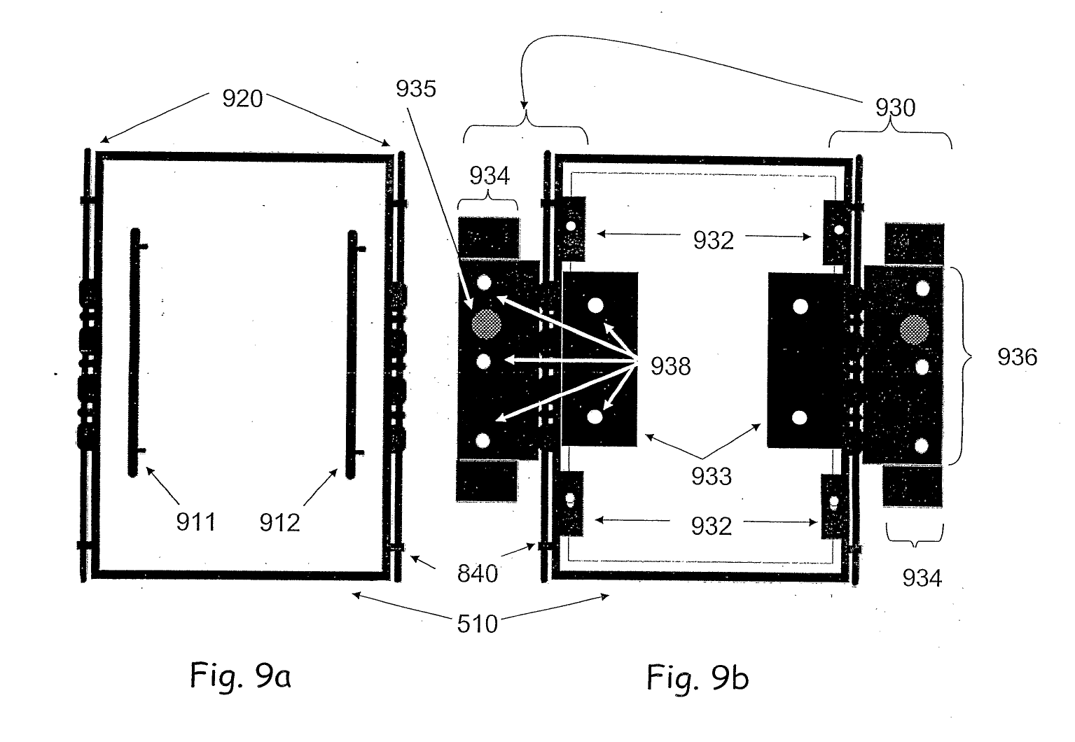

FIG. 5 is a schematic illustration of a preferred embodiment 500 of the present invention which illustrates closed door 510 being hinged on both the left and the right sides, wherein electromagnets are used to lock and release door 510 appropriately on the left and right sides, as detailed in FIGS. 8-10 below.

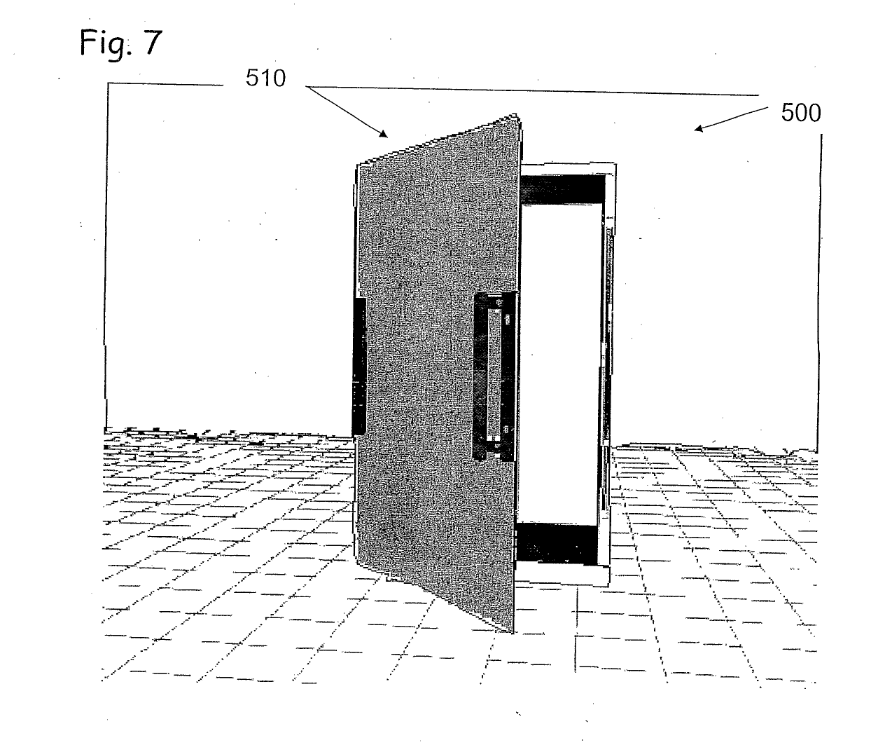

FIG. 6 is a schematic illustration of a preferred embodiment of exemplary refrigerator 500 of the present invention, which illustrates door 510 being opened on the left side.

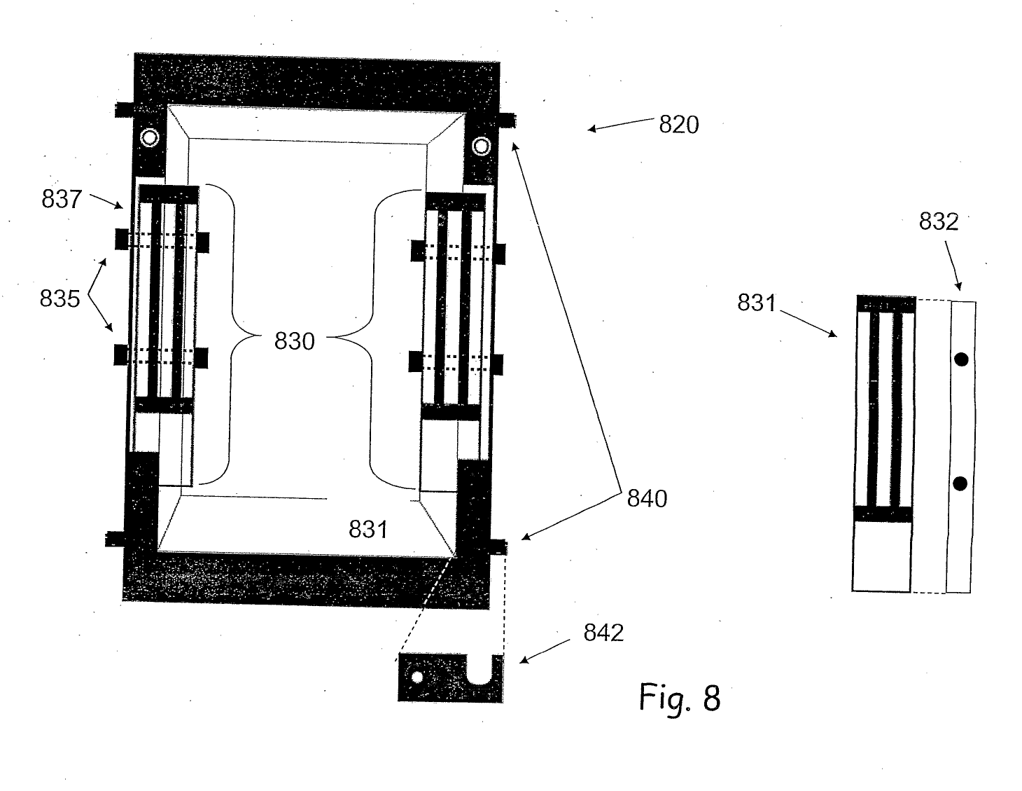

FIG. 7 is a schematic illustration of a preferred embodiment of exemplary refrigerator 500 of the present invention, which illustrates door 510 being opened on the right side.

FIG. 8 is a schematic illustration of a preferred embodiment of exemplary refrigerator of the present invention, which illustrates the refrigerator frame 820, with the door removed. A pair of 300 newton electromagnets 830 are positioned to “lock” the door from the left and right sides, respectively. Electromagnet 830 is also shown separately 831, alongside a side view 832. Hinge-pivot bar recesses 840 are shown in the front view and an exploded end view 842. Electromagnets 830 are attached by bolts 835 to frame casing 837.

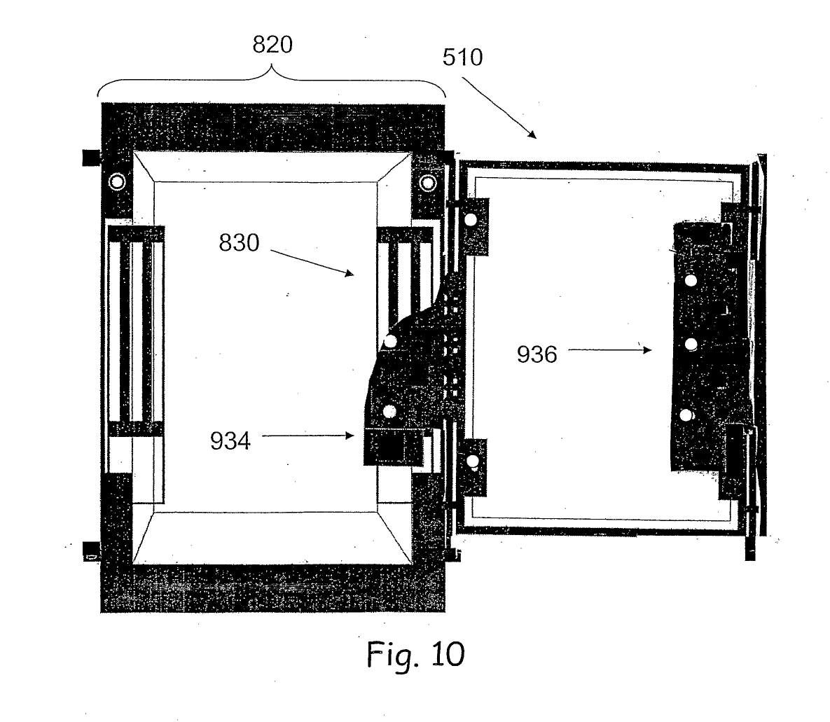

FIGS. 9a and 9b are front and rear views of door 510 as shown in FIGS. 5, 6 and 7, showing the details of overall hinging mechanism 930. The hinge-pivot bars 920 are shown inserted into respective hinge-bar positioning recesses 840. FIG. 9a shows a left-side door handle 911 and a right-side door handle 912. Each hinging mechanism 930 has one side attached to door 510, for example bolted to two small door-side segments each marked 932 and one large door-side segment each marked 933, as shown. Each electromagnet of FIG. 8 is associated with a special magnetic bar 934, which is bolted to a frame-side segment 936 by an exemplary three bolts 938 to the back of the door and a further two bolts to the frame of the refrigerator.

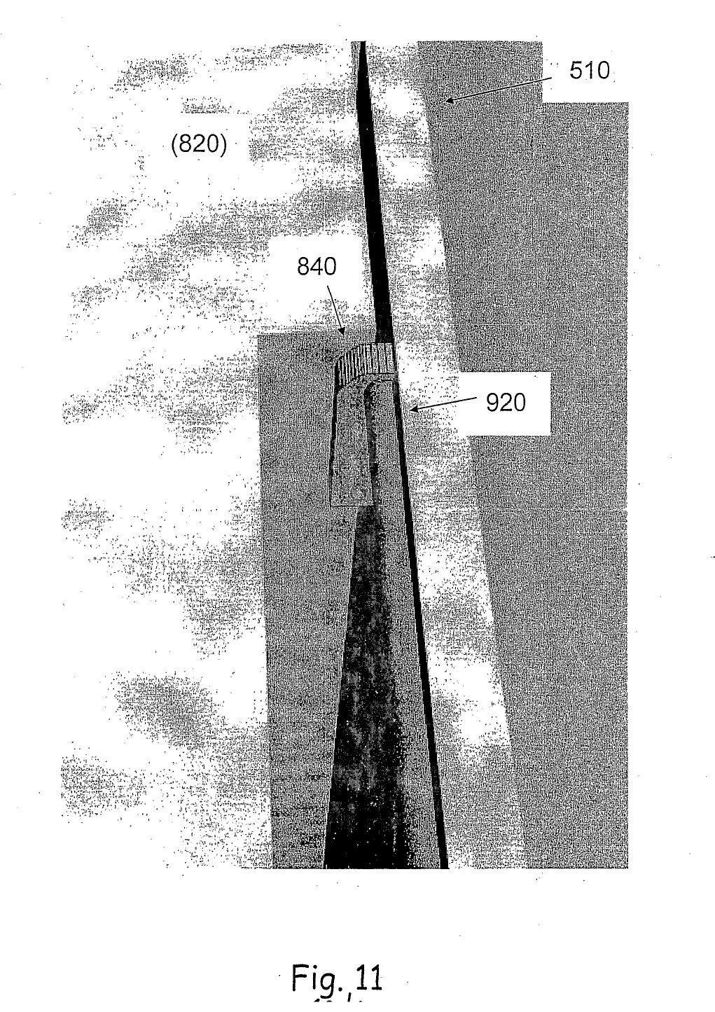

FIG. 10 is a schematic illustration of an embodiment of the present invention which illustrates the door being opened from the left side, and showing more details of hinging mechanism 930 as shown in FIG. 9b. Refrigerator frame 820 is “locked” to door 510 by the interaction of electromagnet 830 locking onto special magnetic bar 934. Open-side hinge 936 is shown folded back against door 510, which is the position it remains in from the time it is deactivated as a hinge to enable the door to be opened from the opposite side. Open-side hinge 936 and special magnetic bar 934 are shown partially “cut-away” to show their position relative to electromagnet 830.

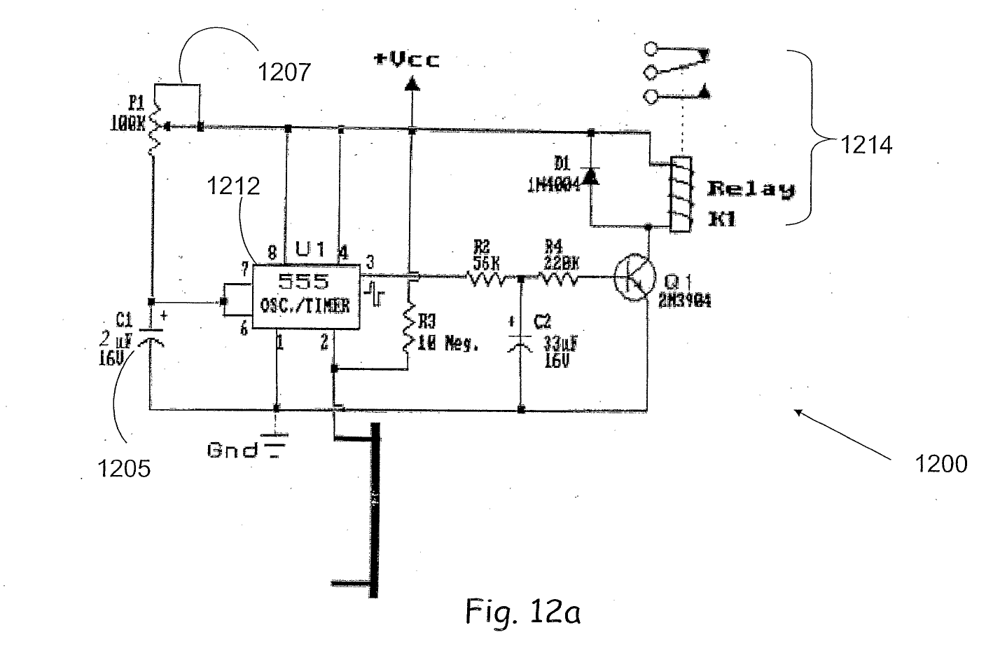

FIG. 11 is a schematic illustration of an embodiment of the present invention which illustrates the door being closed against frame 820. Hinge-pivot bar 920 is seen to be positioned in hinge-pivot bar recesses 840, and kept in place by door 510 being closed, and locked in place by the electromagnet—in this illustration on the left side.

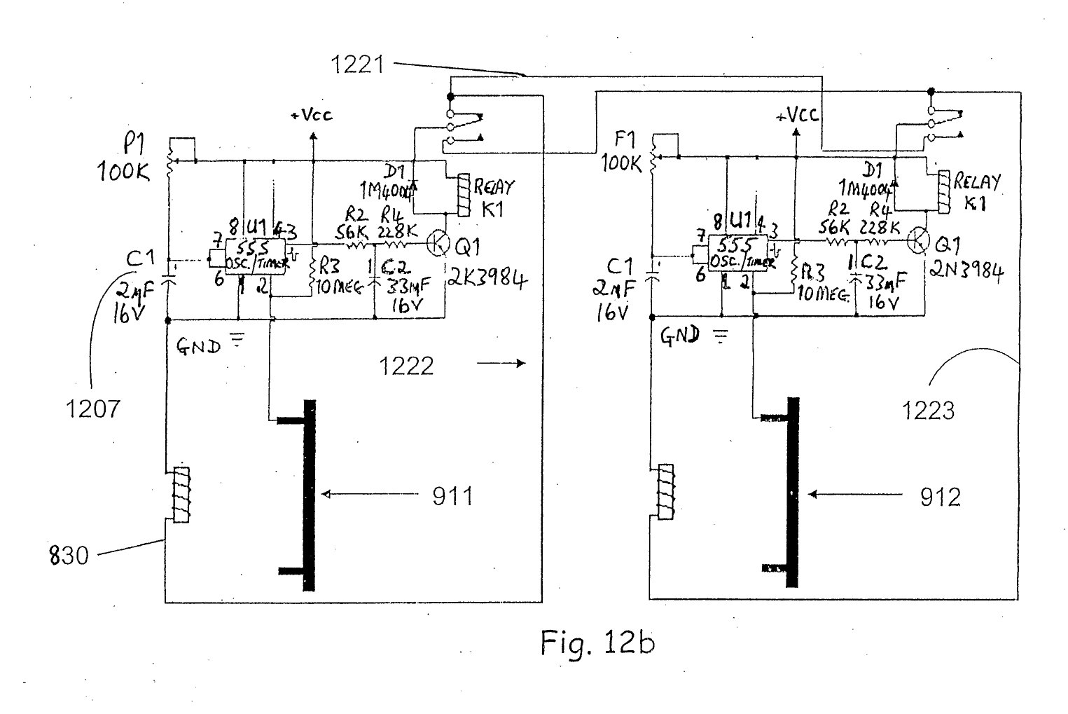

FIGS. 12a and 12b are schematic diagrams of the electronic circuitry which controls the opening and closing of the door, constructed according to the principles of the present invention. FIG. 12a illustrates the exemplary circuit components used as a sensor, for control and to set the delay in each electromagnet, which preferably remain closed for approximately one or two seconds when the door is closed on a particular side. A small capacitor 1205 and a potentiometer 1207 control the time delay. Electromagnet 830, shown in FIG. 12b, is activated by a sensor circuit 1200, which includes, for example, a “555” oscillator/timer 1212 and a milliampere-to-ampere relay 1214.

FIG. 12b illustrates the coordination of two of the circuits of FIG. 12a to interact with both left-side door handle 911 and right-side door handle 912. Relay 1214, which is also activated by sensor circuit 1200, is connected to left-side door handle 911. When closed, electromagnet 830 preferably, to prevent undesirable movement of the door, has a force of approximately 300 kilograms. When someone extends a hand to open the door, sensor circuit 1200 activates relay 1214 to open the electromagnet on that side to enable the door to be opened. 1200 and 1214 are shown in FIG. 12a.

An interlock in the circuitry, represented by wires 1221, 1222 and 1223, assures that both electromagnets 830 cannot be opened at the same time, as will be understood by someone well-versed in the art. With reference now to FIG. 9, a small permanent magnet 935 glued into frame-side segment 936 of the hinge on each side, holds frame-side segment 936 closed against the corresponding large door-side segment 933 of the hinge when electromagnet 830 as shown in FIG. 8 is opened.

It is to be understood that the phraseology and terminology employed herein are for the purpose of description, and should not be regarded as limiting. Thus, the present disclosure illustrates, by way of example, the invention being applied to specific activating systems, it is to be understood that it may be applied as well to other systems, without departing from the scope and spirit of the present invention.

It is important, therefore, that the scope of the invention is not construed as being limited by the illustrative embodiments set forth herein. Other variations are possible within the scope of the present invention as defined in the appended claims and their equivalents.

1. A system for opening doors, windows, hatches, or other apertures or openings, that has multiple opening means, to enable the door, window, hatch, or other aperture or opening, to be opened from at least two sides, said system comprising:
a door, window, hatch, or other aperature or opening with handles on at least any two sides;
a frame, against which said door, window, hatch, or other aperature or opening closes on at least said two sides, and from which said door, window, hatch, or other aperture or opening opens from only one side at a time;
locking and releasing means on each of the sides from which said door, window, hatch, or other aperture or opening opens;
at least one hinge attached to each of the sides from which said door, window, hatch, or other aperture or opening opens;
a special control bar attached to each said hinge, said bar substantially locked onto a respective control system when in contact with said control bar at the time said control system is activated; and
a control circuit, comprising a sensor and a relay, associated with each of said handles, whereby if a person extends a hand to open the door, window, hatch, or other aperture or opening from the handle on one side, a sensor on that side activates a corresponding relay to operate said control system on that side and said hinge on that side is retracted,
such that said door, window, hatch, or other aperture or opening can be opened from at least two sides, but only from one side at a time.

2. The control system according to claim 1, wherein the same is electronic, electromagnetic, electro-optic, hydraulic, pneumatic, mechanical, or other.

3. The operation of the control system according to claim 1, wherein the same is operated manually, electro-optically, by laser, remote control or in any other way.

4. The system according to claim 1, wherein said control system further comprises a time delay to set the delay in each control bar, which remains closed for a preset amount of time when the door, window, hatch, or other aperture or opening is closed on a corresponding side.

5. The system according to claim 1, wherein said control circuit further comprises an interlock operative to assure that said door, window, hatch, or other aperature or opening can be opened only from one side at a time.

6. The operation of the control system according to claim 2, wherein the same is operated manually, electronically, electro-optically, by laser, remote control or in any other way.
